(19) United States
(12) Patent Application Publication
(10) Pub. No.: US 2005/0213916 A1
(43) Pub. Date: Sep. 29, 2005

(54) Method of manufacturing optical waveguide device

(75) Inventors: Chie Fukuda, Yokohama-shi (JP); Tetsuya Hattori, Yokohama-shi (JP); Morihiro Seki, Yokohama-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Sumitomo Electric Industries, Ltd., Osaka-shi (JP)

(21) Appl. No.: 11/074,898

(22) Filed: Mar. 9, 2005

(30) Foreign Application Priority Data
Mar. 26, 2004 (JP) 2004-092408

(51) Int. Cl. G02B 6/10

(52) U.S. Cl. 385/132

(57) ABSTRACT

A method of manufacturing an optical waveguide device with low scattering loss is provided. This method comprises, in the following order, the steps of forming a groove by etching in a cladding member having a glass region including a first dopant that lowers the softening temperature of the glass region, heat treating the cladding member at a temperature that is higher than the lowered softening temperature, forming a core within the groove, and forming an overcladding layer composed of glass including a second dopant over the core and the cladding member. Alternatively, this method comprises the steps of forming a groove by etching in a cladding member having a glass region including one of elemental germanium, elemental phosphorus, and elemental boron, heat treating the cladding member after the formation of the groove, forming a core within the groove, and forming an overcladding layer over the core and the cladding member.

### BACKGROUND OF THE INVENTION

1. Field of the Invention

The present invention relates to a method of manufacturing an optical waveguide device.

2. Description of the Background Art

Japanese Patent Application Publication No. 2000-121859 discloses a method of manufacturing an embedded type optical waveguide device. This method involves manufacturing an optical waveguide device by (1) depositing an undercladding layer over a quartz substrate, (2) forming a mask over the undercladding layer, (3) forming a groove for accommodating a core by the use of the mask, (4) depositing a core layer over the undercladding layer, (5) forming a core by leaving the core layer inside the groove and removing with chemical-mechanical polishing the other portions of the core layer on the undercladding layer, and (6) forming an overcladding layer over the core and the undercladding layer.

Japanese Patent Application Publication No. 2003-161852 discloses a method of manufacturing a dielectric waveguide device. This method involves manufacturing an optical waveguide device by (1′, 2′) forming a mask over a glass substrate having a refractive index of 1.445, (3′) forming a groove on the substrate using the RIE method by etching portions of the substrate that are exposed from the mask, (4′) forming a glass film that has a refractive index of 1.456 and will serve as a core, using an ICP-CVD apparatus, in the groove and over the mask, (5′) removing the mask by wet etching, and (6′) depositing a glass layer that will serve as an overcladding.

With the methods disclosed in Japanese Patent Application Publication Nos. 2000-121859 and 2003-161852, a groove for accommodating a core is formed by etching. The sides and bottom of the groove are not perfectly flat, and have sub-micron bumps and pits. Since light that propagates through the optical waveguide device propagates while permeating the sides and the bottom of the groove, the bumps and pits on the sides and bottom of the groove scatter the light that propagates through the optical waveguide device. Accordingly, the scattering loss of the optical waveguide device increases.

### SUMMARY OF THE INVENTION

It is an object of the present invention to provide a method of manufacturing an optical waveguide device having low scattering loss.

The method of manufacturing an optical waveguide device that is provided as one aspect of the present invention comprises, in the following order, the steps of forming a groove by etching on a cladding member that has a glass region including a first dopant, the first dopant lowering the softening temperature of the glass region; heat treating the cladding member at a first temperature that is higher than the lowered softening temperature of the glass region; forming a core within the groove; and forming an overcladding layer over the core and the cladding member, the overcladding layer being made of a glass including a second dopant.

The method of manufacturing an optical waveguide device that is provided as another aspect of the present invention comprises the steps of forming a groove by etching on a cladding member that has a glass region including one of germanium element, phosphorus element, and boron element; heat treating the cladding member after the formation of the groove; forming a core within the groove; and forming an overcladding layer over the core and the cladding member.

Advantages of the present invention will become apparent from the following detailed description, which illustrates the best mode contemplated to carry out the invention. The invention is capable of other and different embodiments, the details of which are capable of modifications in various obvious respects, all without departing from the invention. Accordingly, the accompanying drawings and description are illustrative, not restrictive, in nature.

### BRIEF DESCRIPTION OF THE DRAWINGS

The present invention is illustrated by way of example, and not by way of limitation, in the figures of the accompanying drawings, in which reference numerals refer to similar elements.

FIGS. 1A and 1B illustrate an example of the optical waveguide device manufactured by the method of the present invention. FIG. 1A is a perspective view, and FIG. 1B is a cross sectional view along the I-I line in FIG. 1A.

FIGS. 2A to 2J illustrate an embodiment of the method of the present invention for manufacturing an optical waveguide device. FIG. 2A is a cross sectional view of a cladding member, FIG. 2B is a cross sectional view illustrating how the groove is formed, FIG. 2C is a partial perspective view of the groove immediately after its formation, FIG. 2D is a cross sectional view illustrating how the cladding member is heat treated, FIG. 2E is a partial perspective view of the groove after heat treatment, FIG. 2F is a cross sectional view illustrating how the core film is formed, FIG. 2G is a cross sectional view illustrating coating with an etch-back resist film, FIG. 2H is a cross sectional view illustrating the etch-back being carried out, FIG. 2I is a cross sectional view illustrating the state after etch-back is concluded, and FIG. 2J is a cross sectional view illustrating how the overcladding layer is formed.

### DETAILED DESCRIPTION OF THE INVENTION

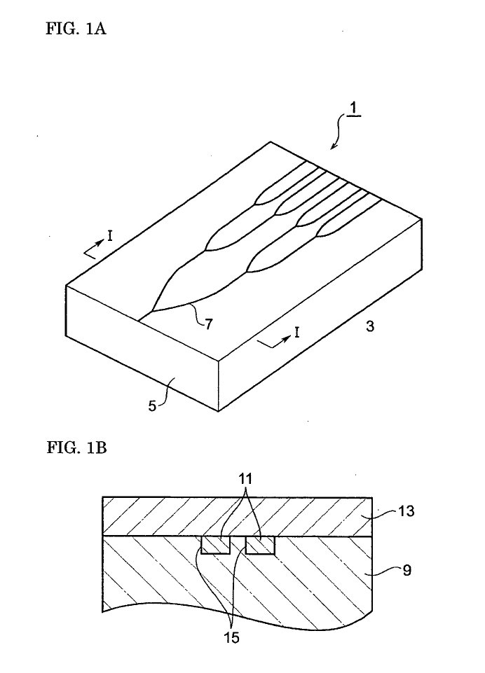

FIGS. 1A and 1B illustrate a splitter, which is an example of the optical waveguide device manufactured by the method of the present invention. FIG. 1A is a perspective view, and FIG. 1B is a cross sectional view along the I-I line in FIG. 1A. An optical waveguide device 1 includes a supporting substrate 5, and an optical waveguide 7 is provided over the supporting substrate 5. The optical waveguide 7 comprises a glass region serving as an undercladding 9, a core 11, and a glass region serving as an overcladding 13. The top portion of the supporting substrate 5 may serve as the undercladding 9. The glass region serving as the undercladding 9 and the glass region serving as the overcladding 13 include a dopant that is capable of lowering the softening temperature when added. The core 11 is provided inside a groove 15 that is provided on the undercladding 9. The method of the present invention for manufacturing an optical waveguide device reduces bumps and pits on the sides and bottom of the groove 15, so there is less scattering loss in the optical waveguide device 1.

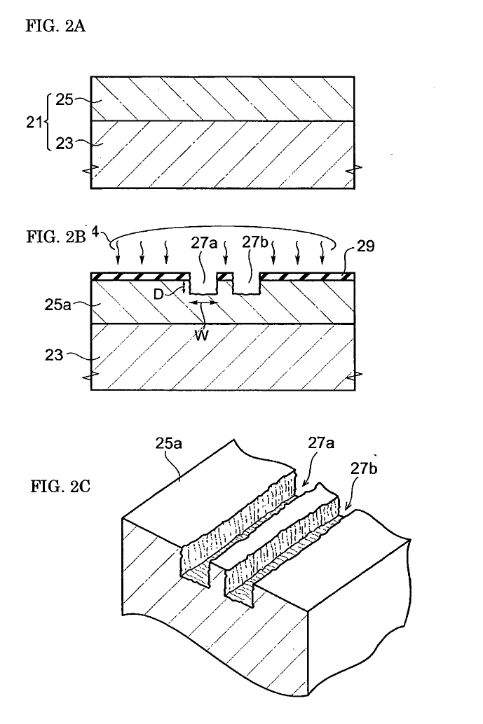

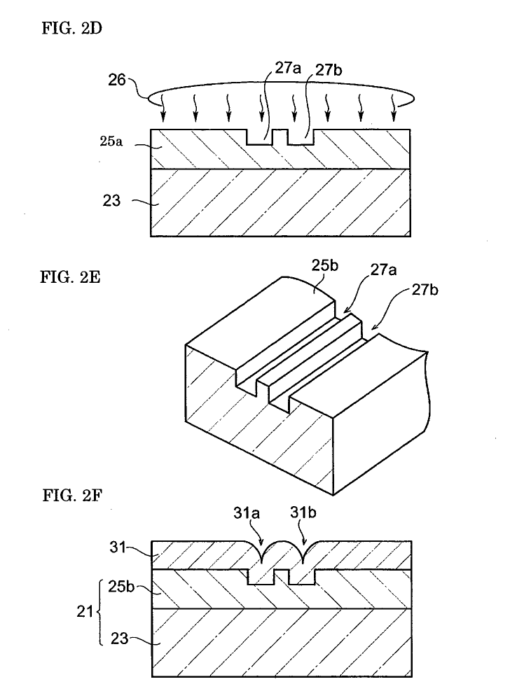

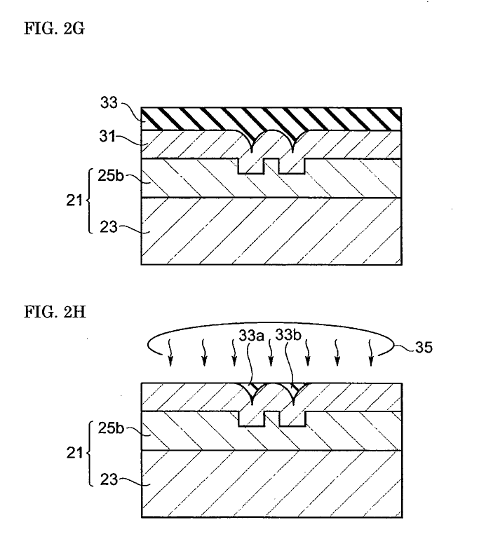

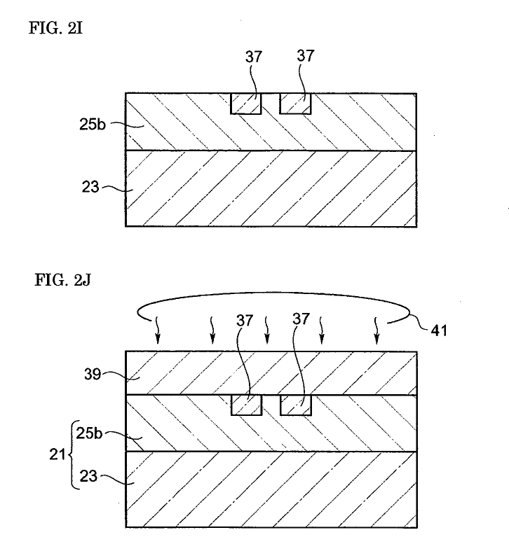

FIGS. 2A to 2J illustrate an embodiment of the method of the present invention for manufacturing an optical waveguide device. FIG. 2A is a cross sectional view of a cladding member. A cladding member 21 has a glass region including a dopant, and this dopant lowers the softening temperature of the glass region. For instance, the cladding member 21 is composed of a substrate 23 and an undercladding layer 25 including a dopant and provided over the substrate 23. A quartz glass substrate or silicon substrate can be used as the substrate 23, for example. When a dopant is added to the base material constituting the undercladding layer 25, the softening temperature of the undercladding layer 25 drops below the softening temperature of the substrate.

In an exemplifying example, the cladding member 21 is prepared as follows. A silicon oxide glass film doped with germanium is deposited as the undercladding layer 25 by the plasma CVD method over a quartz glass substrate. The thickness of the undercladding layer 25 is 28 μm. Oxygen, tetraethoxysilane (TEOS), and tetramethoxygermanium (TMOGe) is used as the raw material gas. The relative refractive index difference Δ₁ of the undercladding layer 25 (refractive index n₁) with respect to the substrate 23 (refractive index n₀) (Δ₁=(n₁²−n₀²)/2n₁²) is 0.3%. Tetramethoxysilane (TMOS) may be used instead of TEOS, and tetramethylgermanium (TMGe) instead of TMOGe, as the raw material gas.

FIG. 2B is a cross sectional view illustrating how the groove is formed. Grooves 27a and 27b are formed on the cladding member 21 by etching. In an exemplifying example, a mask 29 is formed by coating the undercladding layer 25 with an etching resist and then patterning by photolithography. This mask 29 is used to subject the cladding member 21 to reactive ion etching (RIE) 24 with an etching gas such as C₂F₆ gas. The width W of the groove is 6 μm and the depth D is 6 μm. A metal mask can also be used instead of the mask 29 made of a resist. Also, at least one of CF₄, CHF₃, and C₄F₈ may be used instead of or in addition to the C₂F₆ gas. After the etching 24, the mask 29 over the undercladding layer 25a is removed.

FIG. 2C is a partial perspective view of the groove immediately after its formation. There are bumps and pits on the sides and bottom of the grooves 27a and 27b of the cladding member 21. Of the bottom of the grooves 27a and 27b, the arithmetic mean roughness Ra which is measured with a three-dimensional surface roughness gauge (3D-SEM) is approximately 30 nm. The arithmetic mean roughness is obtained by (1) sampling a portion from the surface shape measured by 3D-SEM up to the standard length L, (2) obtaining a function f(x) expressing the absolute value of the deviation from the mean line of the surface shape up to the measured curve in the sampled portion, and (3) finding the mean value of f(x).

FIG. 2D is a cross sectional view illustrating how the cladding member is heat treated. FIG. 2E is a partial perspective view of the groove after the heat treatment. After the grooves 27a and 27b have been formed, the cladding member 21 is subjected to a heat treatment 26. Since the undercladding layer 25a in which the grooves have been formed includes a dopant that lowers the softening temperature, there is a reduction in the roughness of the sides and bottom of the grooves 27a and 27b after the heat-treatment of the undercladding layer 25b. The temperature of the heat treatment 26 is preferably 700 degrees centigrade or higher. In order to avoid distortion of the substrate, it is preferable for the temperature of the heat treatment to be no higher than 1100 degrees centigrade. The atmosphere in the heat treatment 26 can be oxygen, nitrogen, air, helium, argon, or the like. In an exemplifying example, the heat treatment is conducted for about 4 hours, in an oxygen atmosphere, at 900 degrees centigrade. In this case, the roughness Ra of the bottom of the grooves after the heat treatment is approximately 2 nm.

FIG. 2F is a cross sectional view illustrating how the core film is formed. A core film 31 is formed over the cladding member 21 and the grooves 27a and 27b. Grooves 31a and 31b corresponding to the grooves 27a and 27b remain in the core film 31. The bottom of the grooves 31a and 31b does not reach inside the grooves 27a and 27b.

In an exemplifying example, a germanium-doped silicon oxide core film 31 that will become the core of the optical waveguide device is deposited by plasma CVD over the undercladding layer 25b and the grooves 27a and 27b. The raw material gas can be oxygen and TMOS. In order to fill the grooves 27a and 27b with the core film, the thickness of the core film 31 is preferably at least about 1.5 times the depth of the grooves. The depth of the grooves 27a and 27b is 6 μm, and the film thickness on top of the substrate is 9 μm. The relative refractive index difference Δ₂ of the core film 31 (refractive index n2) with respect to the substrate 23 (Δ₁=(n₂²−n₀²)/2n₂²) is 0.75%. In a preferred embodiment, the relative refractive index difference of the core film 31 is at least 0.3% greater than the relative refractive index difference of the undercladding layer 25b.

FIG. 2G is a cross sectional view illustrating coating with an etch-back resist. The core film 31 is coated with an etch-back resist film 33. The resist film 33 is thick enough to embed the grooves 31a and 31b. In an exemplifying example, the core film 31 is spin coated with a thick film of the resist film 33 at a speed of 3000 rpm. This resist film is baked at 100 degrees centigrade. The thickness of the resist film is 6 μm and the bumps and pits in the surface of the resist film 33 are 0.2 μm.

FIG. 2H is a cross sectional view illustrating how etch-back occurs, and FIG. 2I is a cross sectional view illustrating the state after the etch-back is completed. First, the surface layer of the resist film 33 is etched to expose the core film 31. Then, the resist film 33 and the core film 31 are subjected simultaneously to etching 35. The etching conditions used here are such that the etching rate will be substantially the same for both films. This etching 35 allows the core film 31 to remain as cores 37 in just the grooves 27a and 27b.

In an exemplifying example, first, the resist film 33 is dry etched with oxygen gas to expose the surface of the core film 31. Then, the etching gas is switched to a mixed gas of C₂F₆ and oxygen, and the resist film 33 and the core film 31 are etched. The etching rate of the resist film 33 and the etching rate of the core film 31 can be kept the same by adjusting the mix ratio of the etching gas. For instance, the flux ratio of oxygen and C₂F₆ can be set at 100:14.

Heat treatment is performed after the formation of the core 37. This heat treatment reduces the size of the bumps and pits on the top of the core, and also eliminates any impurities that might remain in the core. In an exemplifying example, the core 37 and the undercladding layer 25b are heat treated in an oxygen atmosphere for approximately 10 hours at 1000 degrees centigrade.

FIG. 2J is a cross sectional view illustrating how the overcladding layer is formed. An overcladding layer 39 is formed over the cladding member 21 and the core 37. The overcladding layer is composed of glass including a second dopant, and the second dopant is preferably one that lowers the softening temperature of the overcladding layer. This reduces the roughness of the interface between the overcladding layer 39 and the core 37. Also, the overcladding layer 39 is preferably formed under the same conditions as the undercladding layer 25. As a result, the core 37 is surrounded by cladding having substantially the same refractive index.

In an exemplifying example, the overcladding layer 39, which is a silicon oxide glass film doped with germanium, is deposited by plasma CVD over the core 37 and the undercladding layer 25b. The thickness of the overcladding layer 39 is 28 μm. The raw material gas can be oxygen, TEOS, and TMOGe. The relative refractive index difference Δ₃ of the overcladding layer 39 (refractive index n₁) with respect to the quartz glass substrate (Δ₃=(n₃²−n₀²)/2n₃²) is 0.3%, for example. TMOS may be used instead of TEOS, and TMGe may be used instead of TMOGe as the raw material gas.

After the formation of the overcladding layer 39, the overcladding layer is heat treated at a second temperature that is the same or higher than the softening temperature of the overcladding layer. This heat treatment 41 reduces the size of the bumps and pits at the interface between the core and the cladding, and also eliminates any impurities that might remain in the second cladding. In an exemplifying example, the core 37 and the cladding layers 25b and 39 are heat treated in an oxygen atmosphere for approximately 10 hours at 1000 degrees centigrade.

The overcladding layer 39 preferably includes a dopant which is one of germanium element, phosphorus element, and boron element. This reduces the roughness of the interface between the overcladding layer 39 and the core 37.

The waveguide loss of an optical waveguide device formed as above is 0.05 dB/cm.

As described above, with the method of the present invention for manufacturing an optical waveguide device, the glass region of the cladding member includes a first dopant, which is, for instance, one of germanium element, phosphorus element, and boron element, and lowers the softening temperature. Therefore, the roughness of the sides and bottom of the grooves provided in the undercladding layer can be reduced. As a result, an optical waveguide device with reduced scattering loss is provided.

Germanium element, phosphorus element, and boron element are favorable as the first dopant and second dopant. If these elements are used, the heat treatment temperature can be 1100 degrees centigrade or lower without having to add an excessive amount. Therefore, there is no crystallization or phase separation of the dopants in the cladding layers during heat treatment. As the dopant included in the overcladding and the glass region of the cladding member, one selected from among fluorine element, aluminum element, and sodium element as well as germanium element, phosphorus element, and boron element can be used. One of fluorine element, aluminum element, and sodium element is also capable of reducing the roughness of the sides and bottom of the grooves provided in the cladding member.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

The entire disclosure of Japanese Patent Application No. 2004-092408 filed on Mar. 26, 2004 including specification, claims, drawings, and summary are incorporated herein by reference in its entirety.

1. A method of manufacturing an optical waveguide device, the method comprising the steps of:
forming a groove by etching on a cladding member having a glass region that includes a first dopant that lowers the softening temperature of the glass region;
heat treating the cladding member at a first temperature that is higher than the lowered softening temperature of the glass region;
forming a core within the groove; and
forming an overcladding layer composed of glass including a second dopant over the core and the cladding member.

2. A method of manufacturing an optical waveguide device according to claim 1, wherein the second dopant lowers the softening temperature of the overcladding layer.

3. A method of manufacturing an optical waveguide device, the method comprising the steps of:
forming a groove by etching in a cladding member having a glass region that includes one of germanium element, phosphorus element, and boron element;
heat treating the cladding member after the formation of the groove;
forming a core within the groove; and
forming an overcladding layer over the core and the cladding member.

4. A method of manufacturing an optical waveguide device according to claim 3, wherein the overcladding layer includes one of germanium element, phosphorus element, and boron element.

5. A method of manufacturing an optical waveguide device according to claim 4, further comprising a step of heat treating the overcladding layer at a second temperature at least as high as the softening temperature of the overcladding layer.
